(19) United States
(12) Patent Application Publication
(10) Pub. No.: US 2025/0158295 A1
(43) Pub. Date: May 15, 2025

(54) ANTENNA MODULE

(71) Applicant: Fujikura Ltd., Tokyo (JP)

(72) Inventor: Yuki Suto, Sakura-shi (JP)

(73) Assignee: Fujikura Ltd., Tokyo (JP)

(21) Appl. No.: 18/931,228

(22) Filed: Oct. 30, 2024

(30) Foreign Application Priority Data
Nov. 15, 2023 (JP) 2023-194444

(51) Int. Cl. H01Q 21/28; H01Q 1/02; H01Q 1/22

(52) U.S. Cl. CPC H01Q 21/28; H01Q 1/02; H01Q 1/2208

(57) ABSTRACT

An antenna module includes a first substrate, a second substrate, and a heat dissipation structure. An RFIC (first IC) is provided on a facing surface (first mounting surface) of the first substrate facing the heat dissipation structure. The RFIC is thermally in contact with the heat dissipation structure and processes a high frequency signal. A BBIC (second IC) is provided to be thermally in contact with the heat dissipation structure and to process a baseband signal on a facing surface (second mounting surface) of the second substrate facing the heat dissipation structure. A connecting portion which electrically connects adjacent end portions of the first substrate and the second substrate, is provided. An angle θ between the facing surfaces is a right angle or an acute angle.

### CROSS-REFERENCE TO RELATED APPLICATION

Priority is claimed on Japanese Patent Application No. 2023-194444, filed Nov. 15, 2023, the content of which is incorporated herein by reference.

### BACKGROUND OF THE INVENTION

### Field of the Invention

The present invention pertains to an antenna module.

### Description of Related Art

Japanese Unexamined Patent Application, First Publication No. 2020-123946 discloses an antenna module including a substrate portion bent in a trapezoidal shape, a plurality of patch antennas provided on a front surface of the substrate portion, and an integrated circuit provided on a back surface of the substrate portion.

### SUMMARY OF THE INVENTION

Since the antenna module includes a trapezoidal substrate portion, a wider antenna angle is possible. However, there is a problem in that the module size in a planar direction of the antenna module is increased.

In addition, the antenna module does not consider a heat dissipation structure for the integrated circuit (IC) provided on the back surface of the substrate portion.

The present invention has been made in view of the above-described problems, and an object of the present invention is to provide an antenna module including a heat dissipation structure for an IC and allowing a smaller module size in a planar direction and a wider angle of an antenna.

A first aspect of the present invention relates to an antenna module including a first substrate that includes an antenna and a feed line and that handles a high frequency signal in a millimeter wave band; a second substrate that handles a baseband signal in a frequency band lower than the frequency band of the high frequency signal; and a heat dissipation structure to which the first substrate and the second substrate are attached, wherein a first IC that is thermally in contact with the heat dissipation structure and that processes the high frequency signal is provided on a first mounting surface of the first substrate facing the heat dissipation structure, a second IC that is thermally in contact with the heat dissipation structure and that processes the baseband signal is provided on a second mounting surface of the second substrate facing the heat dissipation structure, a connecting portion that electrically connects adjacent end portions of the first substrate and the second substrate is provided, and an angle between the first mounting surface and the second mounting surface is a right angle or an acute angle.

According to the first aspect of the present invention, the first IC that processes the high frequency signal and the second IC that processes the baseband signal are thermally brought into contact with the heat dissipation structure, allowing the first IC and the second IC to be efficiently cooled. In addition, by disposing the first substrate and the second substrate with respect to the heat dissipation structure at a right angle or an acute angle, a smaller module size in the planar direction and a wider antenna angle are possible. In addition, by electrically connecting the adjacent end portions of the first substrate and the second substrate, the connecting portion can be shortened. Therefore, the signal transmission loss is reduced, making susceptibility to disturbance noise or the like difficult.

A second aspect of the present invention relates to the antenna module according to the first aspect, in which the connecting portion may include a flexible printed circuit board.

A third aspect of the present invention relates to the antenna module according to the first or second aspect, in which the heat dissipation structure may have a prismatic shape, the first substrate may be attached to at least two surfaces of polygonal side surfaces of the heat dissipation structure, and the second substrate may be attached to a first bottom surface of the heat dissipation structure perpendicular to the side surfaces.

A fourth aspect of the present invention relates to the antenna module according to the third aspect, in which a cooling device may be attached to the second bottom surface of the heat dissipation structure opposite the first bottom surface.

A fifth aspect of the present invention relates to the antenna module according to the third or fourth aspect, in which the heat dissipation structure may include a hollow portion with an open second bottom surface opposite the first bottom surface, and may include a cable that passes through the hollow portion and is connected to the second substrate.

A sixth aspect of the present invention is the antenna module according to any one of the first to fifth aspects, in which a ground layer may be provided in an inner layer of the first substrate, and the feed line may be disposed on a first mounting surface side with respect to the ground layer.

A seventh aspect of the present invention is the antenna module according to any one of the first to sixth aspects, in which the first substrate may be attached to the heat dissipation structure via a first metal case that surrounds at least part of the first mounting surface, and the second substrate may be attached to the heat dissipation structure via a second metal case that surrounds at least part of the second mounting surface.

An eighth aspect of the present invention relates to the antenna module according to the seventh aspect, wherein the first metal case may surround at least the first IC.

A ninth aspect of the present invention is the antenna module according to the seventh or eighth aspect, in which the second metal case may surround at least the second IC.

A tenth aspect of the present invention is the antenna module according to any one of the seventh to ninth aspects, in which a ground layer may be provided in an inner layer of the first substrate, the feed line may be disposed on a first mounting surface side with respect to the ground layer, and the feed line may be surrounded by the first metal case.

An eleventh aspect of the present invention may further the antenna module according to any one of the first to tenth aspects, further including a first resin sealing member that resin-seals at least part of a functional component exposed on a surface of the first substrate opposite the first mounting surface; and a second resin sealing member that resin-seals at least part of a functional component exposed on a surface of the second substrate opposite the second mounting surface.

According to one aspect of the present invention, a heat dissipation structure for an IC is provided, making a smaller module size in the planar direction and a wider antenna angle possible.

### BRIEF DESCRIPTION OF THE DRAWINGS

FIG. 1 is a schematic perspective view of an antenna module according to a first embodiment.

FIG. 2 is a cross-sectional configuration diagram of the antenna module according to the first embodiment.

FIG. 3 is an enlarged view of a region A shown in FIG. 2.

FIG. 4 is a cross-sectional configuration diagram of an antenna module according to a second embodiment.

FIG. 5 is a cross-sectional configuration diagram of an antenna module according to a third embodiment.

FIG. 6 is a cross-sectional configuration diagram of an antenna module according to a fourth embodiment.

FIG. 7 is an enlarged view of a region B shown in FIG. 6.

### DETAILED DESCRIPTION OF THE INVENTION

Hereinafter, an antenna module according to each embodiment of the present invention will be described with reference to the accompanying drawings.

### First Embodiment

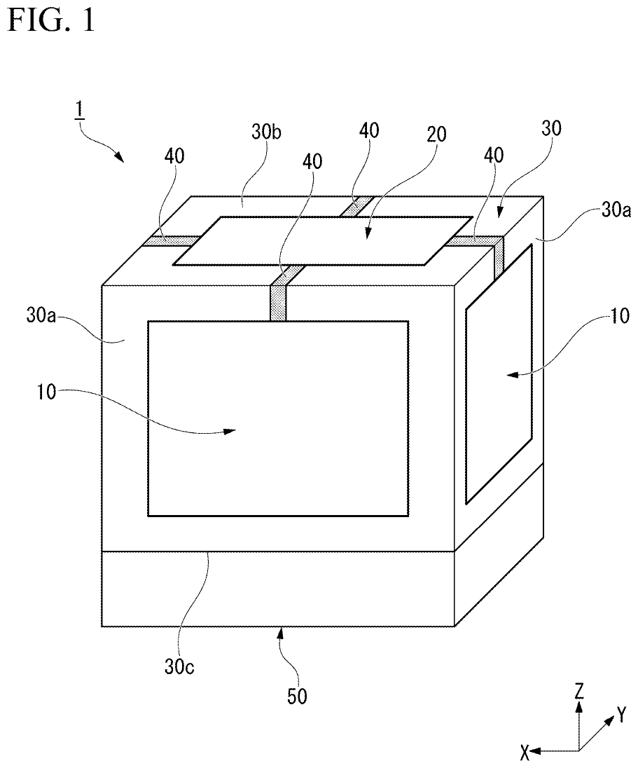

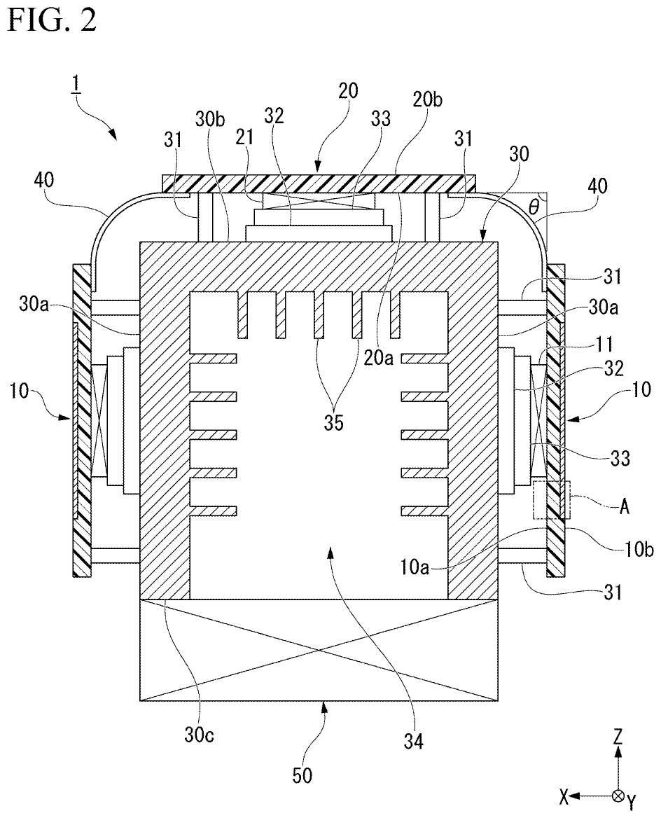

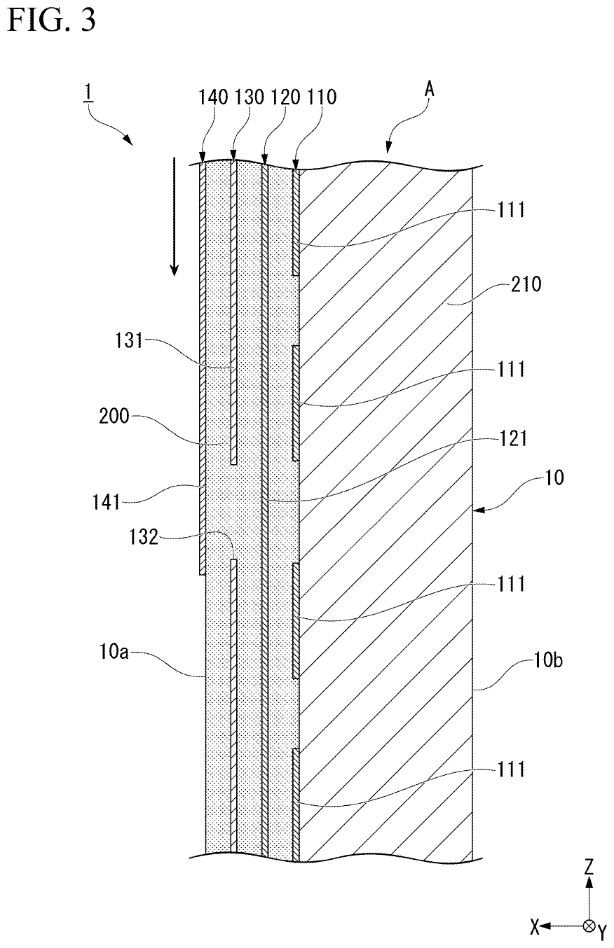

FIG. 1 is a schematic perspective view of an antenna module 1 according to a first embodiment. FIG. 2 is a cross-sectional configuration diagram of the antenna module 1 according to the first embodiment. FIG. 3 is an enlarged view of a region A shown in FIG. 2.

As shown in FIG. 1, the antenna module 1 according to the present embodiment includes a first substrate 10, a second substrate 20, and a heat dissipation structure 30. The heat dissipation structure 30 is formed from, for example, a metal material such as aluminum or stainless steel.

The first substrate 10 is formed in a rectangular plate shape. The first substrate 10 handles a high frequency signal (RF signal) in a millimeter wave band. In addition, the second substrate 20 is formed in a rectangular plate shape. The second substrate 20 handles a baseband signal (BB signal) in a frequency band lower than the high frequency signal. The heat dissipation structure 30 is formed in a prismatic shape.

The heat dissipation structure 30 according to the present embodiment has a quadrangular prismatic shape, and the first substrate 10 is attached to at least two surfaces (in the present embodiment, all four surfaces) of polygonal side surfaces 30a of the heat dissipation structure 30. The second substrate 20 is attached to a first bottom surface 30b perpendicular to the side surfaces 30a of the heat dissipation structure 30. The heat dissipation structure 30 is not limited to a quadrangular prismatic shape and may have triangular or pentagonal or other prismatic shapes.

Adjacent end portions of the first substrate 10 and the second substrate 20 are electrically connected by a connecting portion 40. The connecting portion 40 is, for example, a flexible printed circuit board. The connecting portion 40 may also be an L-shaped connector. A cooling device 50 is attached to a second bottom surface 30c of the heat dissipation structure 30 opposite the first bottom surface 30b.

In addition, in the following description, the XYZ Cartesian coordinate system may be set, and a positional relationship of respective members may be described with reference to the XYZ Cartesian coordinate system. As shown in FIG. 1, a Z-axis direction is set in a direction in which the first bottom surface 30b and the second bottom surface 30c of the heat dissipation structure 30 face each other. The X-axis direction is set in a direction in which two of the four side surfaces 30a of the heat dissipation structure 30 face each other. The Y-axis direction is set in a direction in which the remaining two surfaces of the four side surfaces 30a of the heat dissipation structure 30 face each other. In addition, a side to which the arrow of the XYZ orthogonal axis points is defined as a “+ side,” and the opposite side is defined as a “− side.”

As shown in FIG. 2, an RFIC 11 (first IC) is provided on a facing surface 10a (first mounting surface) of the first substrate 10, which faces the heat dissipation structure 30. Other electronic components (not shown) are provided at positions on a non-facing surface 10b (a surface opposite the facing surface 10a) of the first substrate 10, which are not in the Fresnel zone of the antenna. The Fresnel zone is defined as a region where a path difference is equal to or less than half a wavelength (a region where a phase difference is less than or equal to 180°) when electromagnetic waves propagate from a transmission point to a reception point. The RFIC 11 generates a predetermined high frequency signal from, for example, a baseband signal supplied by the second substrate 20. The first substrate 10 performs both transmission processing and reception processing of the high frequency signal.

The first substrate 10 is a multilayer substrate including a plurality of conductor layers, as shown in FIG. 3. Specifically, the first substrate 10 includes conductor layers that are arranged in the order of a first layer 110, a second layer 120, a third layer 130, and a fourth layer 140 from the outside to the inside (toward the heat dissipation structure 30 side). An insulator 200 such as a liquid crystal polymer is provided between the first layer 110, the second layer 120, the third layer 130, and the fourth layer 140.

The first layer 110 is a first antenna layer, and a plurality of first antenna elements 111 (non-feeding elements) are formed. The first antenna element 111 is disposed in an array on a non-facing surface 10b side of the first substrate 10. The second layer 120 is a second antenna layer, and is formed with a second antenna element 121 (feeding element) disposed on a +X side of the first antenna element 111. The first antenna element 111 and the second antenna element 121 function as antennas.

The third layer 130 forms a ground layer 131 that is electrically grounded. An opening portion 132 is formed in the ground layer 131. The fourth layer 140 is a signal layer, and is formed with a feed line 141 electrically connected to the RFIC 11. The feed line 141 is electromagnetically coupled (for example, capacitively coupled) to the second antenna element 121 via the opening portion 132 of the third layer 130. By this coupling, the first substrate 10 can radiate the high frequency signal supplied from the feed line 141 through the first antenna element 111 and the second antenna element 121, or can output the high frequency signal received by the first antenna element 111 and the second antenna element 121 to the feed line 141.

The form of the antenna is not limited to this configuration, and may also be a form in which the feed line 141 and the second antenna element 121 are electrically and physically connected to each other, or a form in which the first antenna element 111 (non-feeding element) is not provided.

The feed line 141 is disposed on the facing surface 10a side (+X side) with respect to the ground layer 131. The feed line 141 of the present embodiment is exposed on the facing surface 10a of the first substrate 10. The first layer 110 (first antenna element 111) is covered with a protective film 210. The protective film 210 may be a low-loss dielectric that does not adversely affect the transmission or reception of the high frequency signal. In addition, the protective film 210 may have a function of improving the gain of the high frequency signal.

Returning to FIG. 2, a BBIC 21 (second IC) is provided on a facing surface 20a (second mounting surface) of the second substrate 20, which faces the heat dissipation structure 30. In addition, other electronic components (not shown) are provided on a non-facing surface 20b (a surface opposite the facing surface 20a) of the second substrate 20. Each of four sides of an outer edge of the second substrate 20 is connected to one side of each of the four first substrates 10 adjacent to the second substrate 20, via the connecting portion 40. That is, the baseband signal generated on the second substrate 20 is transmitted to the four first substrates 10 via the connecting portion 40.

An angle θ between the facing surface 10a of the first substrate 10 and the facing surface 20a of the second substrate 20 is a right angle (90 degrees). According to this configuration, the module size of the antenna module 1 in a planar direction (X-Y plane direction) can be reduced. The angle θ between the facing surface 10a of the first substrate 10 and the facing surface 20a of the second substrate 20 may be an acute angle (an angle greater than 0 degrees and less than 90 degrees). Even in this case, the module size of the antenna module 1 in the planar direction (X-Y plane direction) can be reduced.

The heat dissipation structure 30 includes a support column 31 on a side surface 30a to which the first substrate 10 is attached. A pedestal portion 32 is further formed on the side surface 30a. The pedestal portion 32 is provided to protrude from the side surface 30a toward the RFIC 11 and is in contact with the RFIC 11 via the heat dissipation sheet 33. As a result, the heat generated in the RFIC 11 is transferred to the heat dissipation structure 30 (pedestal portion 32) via a heat dissipation sheet 33. It is preferable that the support column 31 surround the four sides of the RFIC 11. This can prevent unnecessary radio waves from being emitted externally and make it difficult to access and modify the RFIC 11.

In addition, the heat dissipation structure 30 includes a support column 31 on a first bottom surface 30b, to which the second substrate 20 is attached. The pedestal portion 32 is also formed on the first bottom surface 30b. The pedestal portion 32 is provided to protrude from the first bottom surface 30b toward the BBIC 21 and is in contact with the BBIC 21 via the heat dissipation sheet 33. As a result, the heat generated in the BBIC 21 is transferred to the heat dissipation structure 30 (pedestal portion 32) via the heat dissipation sheet 33. It is preferable that the support column 31 surround the four sides of the BBIC 21. This can prevent unnecessary radio waves from being emitted externally and make it difficult to access and modify the BBIC 21.

The heat dissipation structure 30 has a hollow portion 34 with an open second bottom surface 30c opposite the first bottom surface 30b. A plurality of heat dissipation plates 35 are provided in the hollow portion 34. The cooling device 50 is, for example, a blower that takes in outside air, sends the air to the hollow portion 34, and releases the warm air, which has been heat-exchanged with the heat dissipation plate 35, to the outside.

As described above, the antenna module 1 according to the present embodiment includes the first substrate 10 that includes the antenna and the feed line 141 and that handles the high frequency signal in the millimeter wave band, the second substrate 20 that handles the baseband signal in the frequency band lower than the high frequency signal, and the heat dissipation structure 30 to which the first substrate 10 and the second substrate 20 are attached. The RFIC 11 (first IC) is thermally in contact with the heat dissipation structure 30 and processes the high frequency signal, and is provided on the facing surface 10a (first mounting surface) of the first substrate 10 facing the heat dissipation structure 30. The BBIC 21 (second IC) is thermally in contact with the heat dissipation structure 30 and processes the baseband signal, and is provided on the facing surface 20a (second mounting surface) of the second substrate 20 facing the heat dissipation structure 30. The connecting portion 40 that electrically connects the adjacent end portions of the first substrate 10 and the second substrate 20 is provided. The angle θ between the facing surface 10a and the facing surface 20a is a right angle or an acute angle.

According to this configuration, the RFIC 11 that processes the high frequency signal and the BBIC 21 that processes the baseband signal are thermally brought into contact with the heat dissipation structure 30, allowing the RFIC 11 and the BBIC 21 to be efficiently cooled. In addition, by disposing the first substrate 10 and the second substrate 20 at a right angle or an acute angle with respect to the heat dissipation structure 30, a smaller module size in the planar direction, and a wider angle of the antenna are possible. In addition, by electrically connecting the adjacent end portions of the first substrate 10 and the second substrate 20, the connecting portion 40 can be shortened. Therefore, the signal transmission loss is reduced, making susceptibility to disturbance noise or the like difficult.

In addition, in the present embodiment, the connecting portion 40 includes a flexible printed circuit board. According to this configuration, the electrical connection between the first substrate 10 and the second substrate 20 is easier compared to using an L-shaped connector.

In addition, in the present embodiment, the heat dissipation structure 30 has a prismatic shape. The first substrate 10 is attached to at least two surfaces of the polygonal side surface 30a of the heat dissipation structure 30, and the second substrate 20 is attached to the first bottom surface 30b of the heat dissipation structure 30 perpendicular to the side surface 30a. According to this configuration, since the plurality of first substrates 10 face a plurality of directions (different direction), a wider antenna angle is possible. For example, in a case where the beam directions from the four first substrates 10 are ±45 degrees as in the present embodiment, 360 degrees can be covered without any gaps.

In addition, in the present embodiment, the cooling device 50 is attached to the second bottom surface 30c of the heat dissipation structure 30 opposite the first bottom surface 30b. According to this configuration, the cooling device 50 can be disposed without increasing the module size in the planar direction.

In addition, in the present embodiment, the ground layer 131 is provided in the inner layer of the first substrate 10, and the feed line 141 is disposed on the facing surface 10a side with respect to the ground layer 131. According to this configuration, since the facing surface 10a side is close to the heat dissipation structure 30, the heat dissipation structure 30 functions as an electromagnetic shield for the feed line 141.

### Second Embodiment

A second embodiment of the present invention will be described below. In the following description, the same or equivalent components as those in the above-described embodiment are designated by the same reference numerals, and the description thereof will be simplified or omitted.

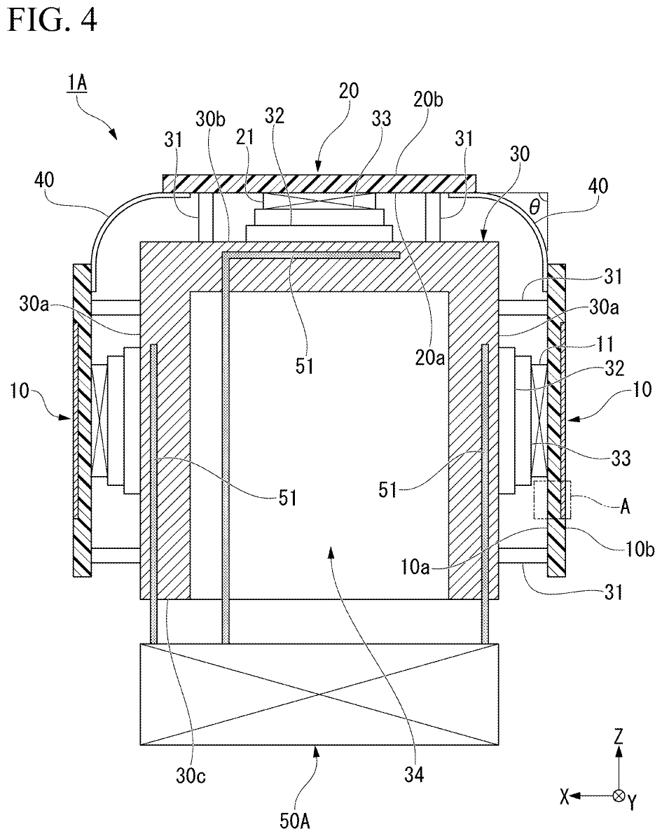

FIG. 4 is a cross-sectional configuration diagram of an antenna module 1A according to the second embodiment.

As shown in FIG. 4, the antenna module 1A according to the second embodiment differs from the above-described embodiment in that the cooling device 50A includes a heat pipe 51.

The heat pipe 51 passes through the interior of the heat dissipation structure 30 and extends to the vicinity of each pedestal portion 32. According to this configuration, the heat obtained at each pedestal portion 32 can be transported to the outside of the heat dissipation structure 30 by the heat pipe 51. Specifically, the cooling device 50A is made of heat dissipation fins, cooling metals, or the like, which are disposed away from the heat dissipation structure 30. As a result, since it is not necessary to provide the heat dissipation plate 35 (see FIG. 2) in the hollow portion 34 of the heat dissipation structure 30, the heat dissipation structure 30 can be downsized. In addition, in the cooling device 50 shown in FIG. 2, there may be cases where forced air cooling cannot be performed due to fan failure, dust adhesion, and the like. However, the heat pipe 51 is less susceptible to such failures because the latent heat of the heat medium is utilized.

### Third Embodiment

A third embodiment of the present invention will be described below. In the following description, the same or equivalent components as those in the above-described embodiment are designated by the same reference numerals, and the description thereof will be simplified or omitted.

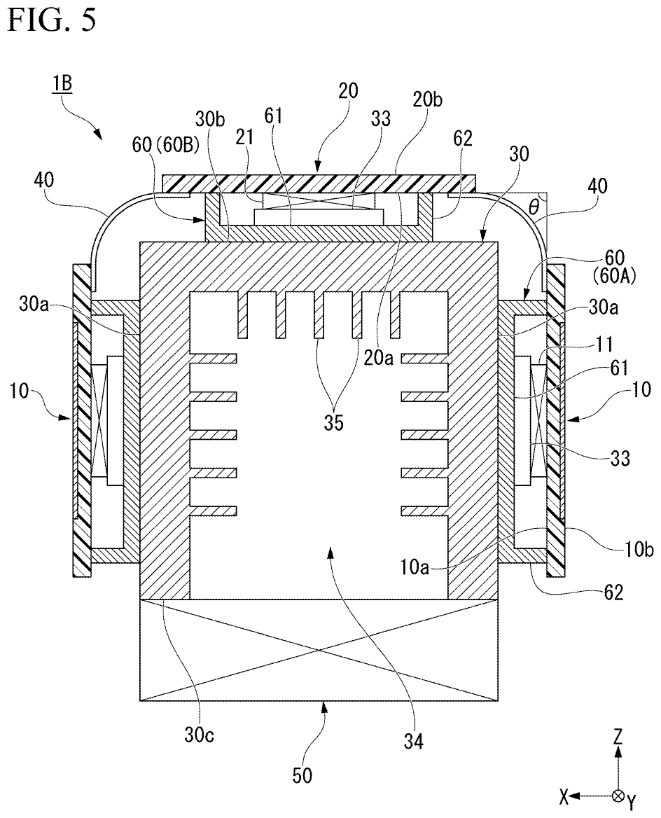

FIG. 5 is a cross-sectional configuration diagram of an antenna module 1B according to the third embodiment.

As shown in FIG. 5, the antenna module 1B according to the third embodiment differs from the above-described embodiments in that a metal case 60 attached to the heat dissipation structure 30 is provided.

The metal case 60 includes a bottom wall portion 61 and a peripheral wall portion 62. The bottom wall portion 61 has a flat plate shape. The peripheral wall portion 62 has a frame shape along an outer peripheral edge of the bottom wall portion 61. That is, the metal case 60 is formed in a bottomed cylindrical shape.

The first substrate 10 is attached to the heat dissipation structure 30 via a first metal case 60A that surrounds at least part of the facing surface 10a. The first metal case 60A surrounds at least the RFIC 11. According to this configuration, the first metal case 60A functions as an electromagnetic shield, thereby suppressing unnecessary radiation caused by a source signal from the RFIC 11.

In addition, the second substrate 20 is attached to the heat dissipation structure 30 via a second metal case 60B that surrounds at least part of the facing surface 20a. The second metal case 60B surrounds at least the BBIC 21. According to this configuration, the second metal case 60B functions as an electromagnetic shield, thereby suppressing unnecessary radiation from a source signal of the BBIC 21.

### Fourth Embodiment

A fourth embodiment of the present invention will be described below. In the following description, the same or equivalent components as those in the above-described embodiment are designated by the same reference numerals, and the description thereof will be simplified or omitted.

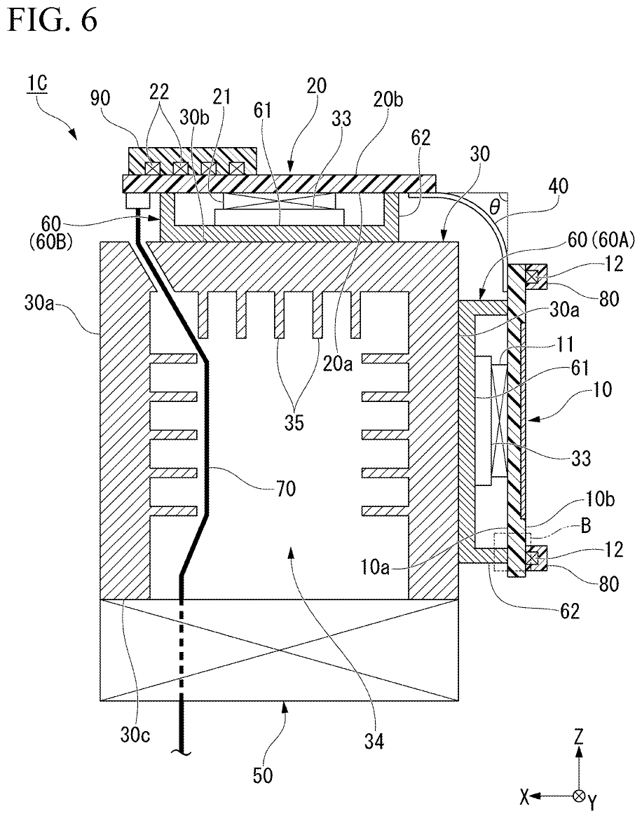

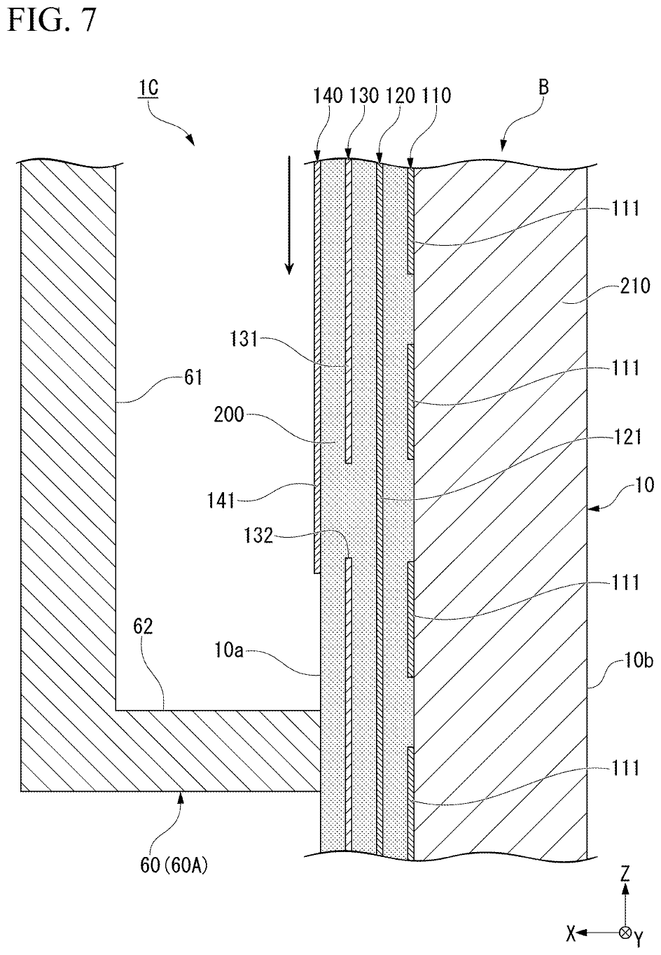

FIG. 6 is a cross-sectional configuration diagram of an antenna module 1C according to the fourth embodiment. FIG. 7 is an enlarged view of a region B shown in FIG. 6.

As shown in FIG. 6, the antenna module 1C according to the fourth embodiment differs from the above-described embodiments in that a cable 70 is provided that passes through the hollow portion 34 of the heat dissipation structure 30 and is connected to the second substrate 20.

The BBIC 21 is connected to, for example, an external device (not shown) via the cable 70 and generates a predetermined baseband signal on the basis of a command from the external device. According to this configuration, since the cable 70 is disposed inside the heat dissipation structure 30, it is possible to create a structure in which the cable 70 does not interfere with the transmission or reception of the radio waves of the antenna.

In addition, in the fourth embodiment, at least part of a functional component 12 exposed on the non-facing surface 10b of the first substrate 10 is resin-sealed by a first resin sealing member 80. Similarly, at least part of a functional component 22 exposed on the non-facing surface 20b of the second substrate 20 is resin-sealed by the second resin sealing member 90. According to this configuration, it is possible to prevent damage, falling-off, or modification by resin-sealing the functional components 12 and 22 that are accessible from the outside.

In addition, as shown in FIG. 7, a ground layer 131 is provided in the inner layer of the first substrate 10, and the feed line 141 is disposed on the facing surface 10a side (+X side) of the ground layer 131. The feed line 141 is enclosed by the first metal case 60A. In a case where a signal leaking from the feed line 141 (signal line) is radiated to the outside, the leaked radio waves and radio waves from the antenna may interfere with each other, adversely affecting the radiation characteristics (radiation pattern). According to the above configuration, the leaked radio waves from the feed line 141 can be electromagnetically shielded from escaping to the outside of the module.

Although preferred embodiments of the present invention have been described and explained above, it should be understood that these embodiments are exemplary and should not be considered as limiting. Additions, omissions, substitutions, and other modifications can be made without departing from the scope of the present invention. Therefore, the present invention should not be considered as being limited by the aforementioned description but is only limited by the claims.

In addition, it is possible to appropriately replace the constituent elements in the above-described embodiments with well-known constituent elements without departing from the spirit of the present invention, and the above-described embodiments and modification examples may be appropriately combined.

What is claimed is:

1. An antenna module comprising:
a first substrate that includes an antenna and a feed line and that handles a high frequency signal in a millimeter wave band;
a second substrate that handles a baseband signal in a frequency band lower than the frequency band of the high frequency signal; and
a heat dissipation structure to which the first substrate and the second substrate are attached,
wherein a first IC that is thermally in contact with the heat dissipation structure and that processes the high frequency signal is provided on a first mounting surface of the first substrate facing the heat dissipation structure,
a second IC that is thermally in contact with the heat dissipation structure and that processes the baseband signal is provided on a second mounting surface of the second substrate facing the heat dissipation structure,
a connecting portion that electrically connects adjacent end portions of the first substrate and the second substrate is provided, and
an angle between the first mounting surface and the second mounting surface is a right angle or an acute angle.

2. The antenna module according to claim 1,
wherein the connecting portion includes a flexible printed circuit board.

3. The antenna module according to claim 1,
wherein the heat dissipation structure has a prismatic shape,
the first substrate is attached to at least two surfaces of polygonal side surfaces of the heat dissipation structure, and
the second substrate is attached to a first bottom surface of the heat dissipation structure perpendicular to the side surfaces.

4. The antenna module according to claim 3,
wherein a cooling device is attached to a second bottom surface of the heat dissipation structure opposite the first bottom surface.

5. The antenna module according to claim 3,
wherein the heat dissipation structure includes a hollow portion with an open second bottom surface opposite the first bottom surface, and
the antenna module includes a cable that passes through the hollow portion and is connected to the second substrate.

6. The antenna module according to claim 1,
wherein a ground layer is provided in an inner layer of the first substrate, and
the feed line is disposed on a first mounting surface side with respect to the ground layer.

7. The antenna module according to claim 1,
wherein the first substrate is attached to the heat dissipation structure via a first metal case that surrounds at least part of the first mounting surface, and
the second substrate is attached to the heat dissipation structure via a second metal case that surrounds at least part of the second mounting surface.

8. The antenna module according to claim 7,
wherein the first metal case surrounds at least the first IC.

9. The antenna module according to claim 7,
wherein the second metal case surrounds at least the second IC.

10. The antenna module according to claim 7,
wherein a ground layer is provided in an inner layer of the first substrate,
the feed line is disposed on a first mounting surface side with respect to the ground layer, and
the feed line is surrounded by the first metal case.

11. The antenna module according to claim 1, further comprising:
a first resin sealing member that resin-seals at least part of a functional component exposed on a surface of the first substrate opposite the first mounting surface; and
a second resin sealing member that resin-seals at least part of a functional component exposed on a surface of the second substrate opposite the second mounting surface.
